(19) United States
(12) Patent Application Publication
(10) Pub. No.: US 2014/0362047 A1
(43) Pub. Date: Dec. 11, 2014

(54) TOUCH SENSING CIRCUIT CAPABLE OF ADJUSTING RECEPTION FREQUENCY BAND, AND TOUCH SENSING SYSTEM HAVING SAME

(71) Applicant: SILICON WORKS CO., LTD., Daejeon-si (KR)

(72) Inventors: Yong-Sung Ahn, Ansan-si (KR); Hee-Sop Song, Seongnam-si (KR); Yong-Suk Kim, Daegu-si (KR); Hyung-Seog Oh, Daejeon-si (KR)

(21) Appl. No.: 14/369,225

(22) PCT Filed: Dec. 28, 2012
(86) PCT No.: PCT/KR2012/011697

§ 371 Date: Jun. 27, 2014

(30) Foreign Application Priority Data
Dec. 28, 2011 (KR) 10-2011-0144722

(51) Int. Cl. G06F 3/044; G06F 3/041

(52) U.S. Cl. CPC G06F 3/044; G06F 3/0416; G06F 2203/04111
USPC 345/174

(57) ABSTRACT

The present invention introduces a touch sensing circuit that adjusts a reception frequency band, which adjusts a width of a reception frequency band of a driving signal applied from a driving electrode of a touch screen panel and transferred to a reception electrode of the touch screen panel. The touch sensing circuit adjusts the width of the reception frequency band of the driving signal, which is applied from the driving electrode of the touch screen panel and transferred to the reception electrode of the touch screen panel, by using a high pass filter prepared in the form of a differentiator and a low pass filter prepared in the form of an integrator. In the present invention, resistance values of a plurality of embedded resistors and capacitance of a capacitor are adjusted, so that a driving signal is selectively received according to frequencies, and a received driving signal is amplified with a predetermined amplitude. Accordingly, since a separated filter for removing a noise component included in the driving signal is not required, a system is simplified.

### TECHNICAL FIELD

The present invention relates to a touch sensing circuit, and particularly, to a touch sensing circuit capable of adaptively adjusting a reception frequency band according to a frequency of a driving signal transferred through a reception electrode of a touch screen panel, and a touch sensing system having the same.

### BACKGROUND ART

FIG. 1 illustrates a conventional capacitive touch sensing device.

Referring to FIG. 1, a capacitive touch sensing device 100 includes a touch screen panel 110 and a driving signal detection means 120. The touch screen panel 110 includes a plurality of driving electrodes 111a to 111n that is extended in a row direction and are connected to a plurality of driving channels 112a to 112n, and a plurality of reception electrodes 113a to 113n that is extended in a column direction and are connected to a plurality of sensing channels 114a to 114n. The driving signal detection means 120 detects a driving signal (not illustrated) that is transferred to the reception electrodes 113a to 113n via the driving electrodes 111a to 111n and the touch screen panel 110.

In nodes in which the plurality of driving electrodes 111a to 111n and the plurality of reception electrodes 113a to 113n cross each other, coupling capacitors (not illustrated) are formed. Capacitance of the coupling capacitor is changed when a user makes contact with the touch screen panel 110. Since a driving signal (not illustrated) with the same amplitude and the same frequency is applied to the plurality of driving electrodes 111a to 111n, when there is no contact, the driving signal applied to the driving electrodes 111a to 111n is received in the plurality of reception electrodes 113a to 113n with the same amplitude.

However, when a user makes contact with a some parts and capacitance of a coupling capacitor at the corresponding parts is changed, the amplitude of a driving signal received in a reception electrode including the corresponding parts is different from that of a driving signal received in a reception electrode not including the corresponding parts. The driving signal detection means 120 receives a driving signal, which is applied through the driving electrodes 111a to 111n, through the reception electrodes 113a to 113n via a corresponding coupling capacitor, detects a change included in the received signal, and determines whether there is a touch of a user.

The amplitude and frequency of a driving signal (not illustrated) is decided when the capacitive touch sensing device is manufactured, but the driving signal is received in reception electrodes with changed amplitudes or various frequency components due to the influence of noise through a parasitic capacitor (not illustrated) and a parasitic resistor of the touch screen panel 110. In order to exactly determine a touch of a user, it is necessary to distinguish a noise from a driving signal included in a signal received in the driving signal detection means 120, and to process the signal.

### DISCLOSURE

### Technical Problem

Accordingly, the present invention has been made in an effort to solve the problems occurring in the related art, and an object of the present invention is to provide a touch sensing circuit capable of adjusting a reception frequency band, which can adjust a width of a reception frequency band of a driving signal applied from a driving electrode of a touch screen panel and transferred through a reception electrode of the touch screen panel.

Another object of the present invention is to provide a touch sensing system including a touch sensing circuit capable of adjusting a reception frequency band, which can adjust a width of a reception frequency band of a driving signal applied from a plurality of driving electrodes of a touch screen panel and transferred through a plurality of reception electrodes of the touch screen panel.

### Technical Solution

In order to achieve the above object, according to one aspect of the present invention, there is provided a touch sensing circuit capable of adjusting a width of a reception frequency band of a driving signal applied from a driving electrode installed at one side of a touch screen and transferred to a reception electrode installed at another side of the touch screen, and includes a high pass filter and a low pass filter. The high pass filter allows only a high frequency component of the driving signal to pass therethrough. The low pass filter allows only a low frequency component of a signal, which is output from the high pass filter, to pass therethrough. The high pass filter includes a coupling capacitor, a first resistor, a first amplifier, and a second resistor. The coupling capacitor is generated in a node in which the driving electrode and the reception electrode cross each other. The first resistor has one terminal connected to the reception electrode. The first amplifier has one input terminal grounded, the other terminal connected to the other terminal of the first resistor, and an output terminal through which a differentiation signal is output. The second resistor has one terminal connected to the other input terminal of the first amplifier, and the other terminal connected to an output terminal of the first amplifier.

Furthermore, there is provided a touch sensing circuit, in which a coupling capacitor is generated in a node in which a driving electrode and a reception electrode of a touch screen panel cross each other and a frequency bandwidth of a driving signal applied from the driving electrode and received in the reception electrode is adjusted, includes: a gain circuit configured to amplify the driving signal, which passes through the coupling capacitor and is input to the reception electrode, by preset gain; and a low pass filter configured to allow only a low frequency component of a signal, which is output from the gain circuit, to pass therethrough. The gain circuit includes: a first resistor having a first terminal connected to the reception electrode; a first amplifier having a first input terminal grounded and a second input terminal connected to a second terminal of the first resistor, the first input terminal facing the second input terminal, the first terminal facing the second terminal; and a second resistor having a first terminal connected to the second input terminal of the first amplifier, and a second terminal connected to an output terminal of the first amplifier, the first terminal facing the second terminal. The low pass filter includes: a third resistor having a first terminal connected to the output terminal of the gain circuit; a second amplifier having a first input terminal grounded and a second input terminal connected to a second terminal of the third resistor, the first input terminal facing the second input terminal; and a feedback capacitor having a first terminal connected to the second input terminal of the second amplifier, and a second terminal connected to an output terminal of the second amplifier, the first terminal facing the second terminal. The preset gain is decided by a ratio of the first resistor and the second resistor, and the gain circuit is coupled with the coupling capacitor and operates as a high pass filter for the driving signal.

Furthermore, there is provided a touch sensing system including a plurality of touch sensing circuits, a switching block, and an analog to digital converter, by which it is possible to adjust a width of a reception frequency band of a driving signal applied from a plurality of driving electrodes installed at one side of a touch screen and transferred to a plurality of reception electrodes installed at another side of the touch screen. The switching block switches signals that are output from the plurality of touch sensing circuits. The analog to digital converter converts signals selected from the switching block into digital signals. Each of the plurality of touch sensing circuits includes a differentiator that differentiates the driving signal applied to a corresponding driving electrode and an integrator that integrates an output signal of the differentiator, or a high pass filter that allows only a high frequency component of a corresponding driving signal to pass therethrough, and a low pass filter that allows only a low frequency component of a signal, which is output from the high pass filter, to pass therethrough.

### Advantageous Effects

According to the present invention, resistance values of a plurality of embedded resistors and capacitance of a embedded capacitor are adjusted, so that a driving signal can be selectively received according to frequencies and a received driving signal can be amplified with a predetermined amplitude.

Accordingly, since a separated filter for removing a noise component included in the driving signal is not required, a system is simplified.

### BRIEF DESCRIPTION OF THE DRAWINGS

The above objects, and other features and advantages of the present invention will become more apparent after a reading of the following detailed description taken in conjunction with the drawings, in which:

FIG. 1 illustrates a conventional capacitive touch sensing device;

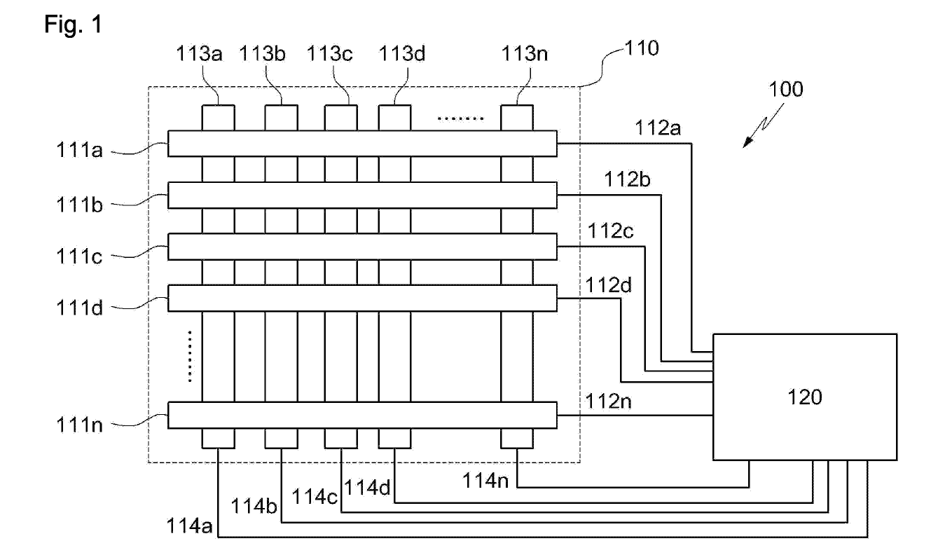

FIG. 2 illustrates a circuit diagram of a touch sensing circuit capable of adjusting a reception frequency band according to an embodiment of the present invention;

FIG. 3 illustrates a pre-stage having a low pass characteristic of the touch sensing circuit illustrated in FIG. 2, and a transfer characteristic graph of the pre-stage;

FIG. 4 illustrates a differentiator having a high pass characteristic of the touch sensing circuit illustrated in FIG. 2, and a transfer characteristic graph of the differentiator;

FIG. 5 illustrates an integrator having a low pass characteristic of the touch sensing circuit illustrated in FIG. 2, and a transfer characteristic graph of the integrator; and

FIG. 6 illustrates a touch sensing system according to the embodiment of the present invention.

### BEST MODE FOR THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

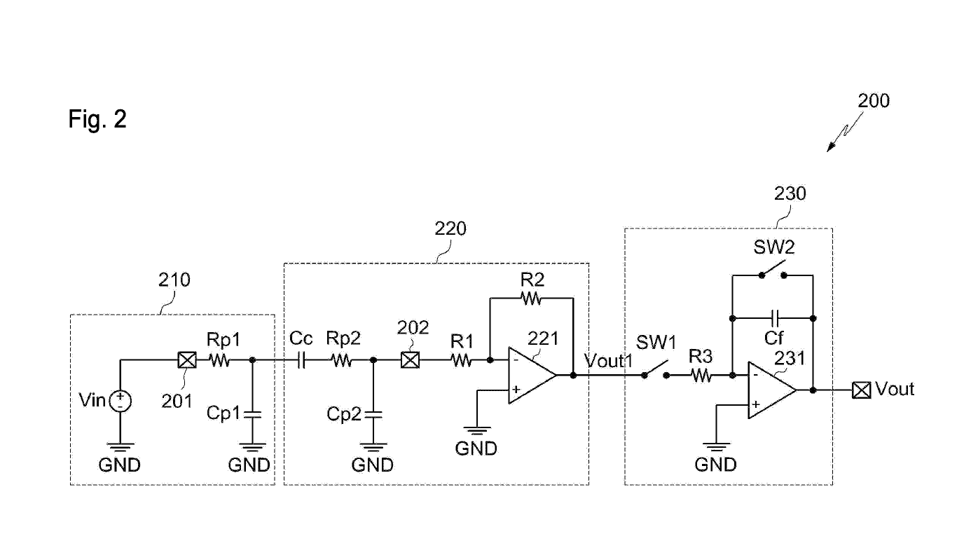

FIG. 2 is a circuit diagram of a touch sensing circuit capable of adjusting a reception frequency band according to an embodiment of the present invention.

Referring to FIG. 2, a touch sensing circuit 200 adjusts a width of a reception frequency band of a driving signal Vin applied from a driving electrode 201 of a touch screen panel and transferred to a reception electrode 202 of the touch screen panel, and includes a pre-stage 210, a differentiator 220, and an integrator 230 in order to perform such a function.

The pre-stage 210 includes a first sheet resistor Rp1 having one terminal to which the driving signal Vin is applied, and a first sheet capacitor Cp1 having one terminal connected to the other terminal of the first sheet resistor Rp1 and the other terminal grounded. The first sheet resistor Rp1 is a resistor component passed by the driving signal Vin input to the driving electrode 201 and reaching a coupling capacitor Cc, and is decided by the material of the driving electrode 201. The first sheet capacitor Cp1 is a capacitive load component passed by the driving signal Vin input to the driving electrode 201 and reaching the coupling capacitor Cc, and is decided by the dielectric constant and thickness of the touch screen panel positioned between the driving electrode 201 and the reception electrode 202.

Unless mentioned otherwise, the structural and physical characteristics of the sheet resistor and the sheet capacitor described in the pre-stage 210 are applied to a sheet resistor and a sheet capacitor as is to be described below.

The differentiator 220 differentiates an output signal of the pre-stage 210 to generate a first output signal Vout1, and includes the coupling capacitor Cc, a second sheet resistor Rp2, a second sheet capacitor Cp2, a first resistor R1, a second resistor R2, and a first amplifier 221.

The coupling capacitor Cc is a capacitor that is generated in a node in which the driving electrode 201 and the reception electrode 202 crosses each other, and has one terminal connected to an output terminal of the pre-stage 210, that is, a common terminal of the first sheet resistor Rp1 and the first sheet capacitor Cp1. The second sheet resistor Rp2 has one terminal connected to the other terminal of the coupling capacitor Cc and the other terminal connected to the reception electrode 202. The second sheet capacitor Cp2 has one terminal connected to the reception electrode 202 and the other terminal grounded. The first resistor R1 has one terminal connected to the reception electrode 202 and the other terminal connected to one input terminal (−) of the first amplifier 221. The second resistor R2 has one terminal connected to the other input terminal (+) of the first amplifier 221 and the other terminal connected to an output terminal of the first amplifier 221.

The integrator 230 integrates the first output signal Vout1 output from the differentiator 220 to generate a final output signal Vout, and includes a signal transfer switch SW1, a reset switch SW2, a third resistor R3, a feedback capacitor Cf, and a second amplifier 231.

The signal transfer switch SW1 switches the first output signal Vout1, which is output from the differentiator 220, to one terminal of the third resistor R3. The other terminal of the third resistor R3 is connected to one input terminal (−) of the second amplifier 231. The feedback capacitor Cf has one terminal connected to the one input terminal (−) of the second amplifier 231, and the other terminal connected to an output terminal of the second amplifier 231 that outputs the final output signal Vout. The reset switch SW2 resets charge charged in the feedback capacitor Cf.

In the above, the electrical connection structure of the circuit constituting the touch sensing circuit 200 according to the embodiment of the present invention and the function of processing the received driving signal Vin have been described on a time basis. In this regard, names of the differentiator and the integrator have been used. Hereinafter, a function of processing the received driving signal Vin of the touch sensing circuit 200 according to the present invention will be described on a frequency basis.

The above description for the circuit illustrated in FIG. 2 relates to the entire of the touch sensing circuit, and may be classified as follows. A part from a reference numeral 201 to a reference numeral 202 is an equivalent model for the display panel 110, and a part from the reference numeral 202 to Vout is a circuit included in the driving signal detection means 120. The driving signal detection means 120 is prepared in the form of an integrated circuit. The differentiator 220 includes both elements of the display panel 110 and elements of the driving signal detection means 120.

When the driving signal detection means 120 to be prepared in the form of the integrated circuit, except for the coupling capacitor Cc included in the display panel 110, will be limitedly described, the first resistor R1, the second resistor R2, and the first amplifier 221 become a gain circuit. In this case, gain is a ratio of the first resistor R1 and the second resistor R2.

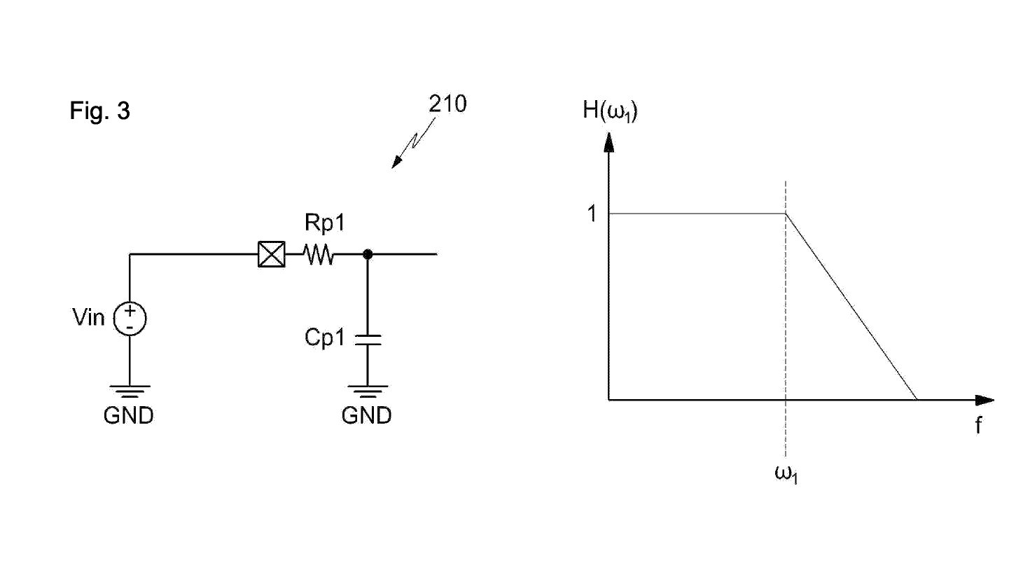

FIG. 3 illustrates the pre-stage having a low pass characteristic of the touch sensing circuit illustrated in FIG. 2, and a transfer characteristic graph of the pre-stage.

Referring to FIG. 3, as well known in the transfer characteristic graph illustrated in the right side, the pre-stage 210 illustrated in the left side has a frequency characteristic the same as that of a low pass filter. A transfer function H(₁) of the pre-stage 210 is expressed by Equation 1 below.

$$H ( {ω}_{1} ) = \frac{1}{1 + Rp 1 \cdot {jω}_{1} Cp 1} \qquad Equation 1$$

In Equation 1 above, Rpt denotes a first sheet resistor, Cp1 denotes a first sheet capacitor, and ₁ denotes a first cut-off frequency of the low pass filter. In frequency components included in the pulse type driving signal Vin, a frequency component relatively higher than the first cut-off frequency (₁), is removed and only a relatively low frequency component passes through the pre-stage 210. In a pass band, the amplitude of a signal does not change.

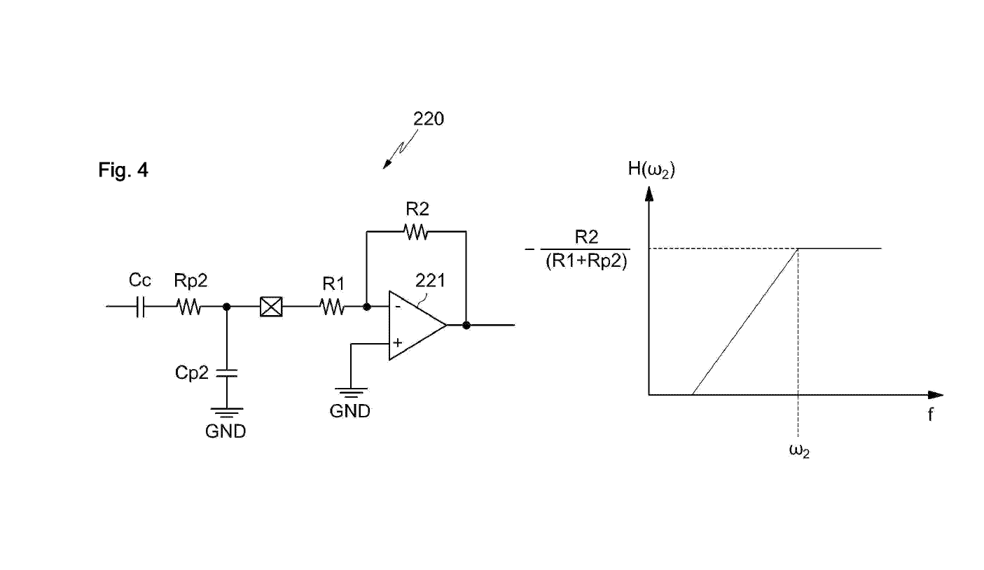

FIG. 4 illustrates the differentiator having a high pass characteristic of the touch sensing circuit illustrated in FIG. 2, and a transfer characteristic graph of the differentiator. Referring to FIG. 4, as well known in the transfer characteristic graph illustrated in the right side, the differentiator 220 illustrated in the left side has a frequency characteristic the same as that of a high pass filter. A transfer function H(₂) of the differentiator 220 is expressed by Equation 2 below.

$$H ( {ω}_{2} ) = - \frac{R 2}{R 1 + R p 2 + \frac{1}{j {ω}_{2} Cc}} = - \frac{j {ω}_{2} Cc \cdot R 2}{1 + j {ω}_{2} Cc ( R 1 + Rp 2 )} \qquad Equation 2$$

R1 denotes a first resistor, R2 denotes a second resistor, Rp2 denotes a second sheet resistor, and Cc denotes a coupling capacitor. Of frequency components relatively lower than the first cut-off frequency (₁) having passed through the pre-stage 210, a frequency component lower than a second cut-off frequency (₂) is removed in the differentiator 220 having a characteristic of the high pass filter. A signal in a pass band is amplified by gain, which may be expressed by resistance values of the first resistor R1, the second resistor R2, and the second sheet resistor Rp2 as expressed by Equation 3, and a minus sign (−) indicates that the first amplifier 221 is used in the form of negative feedback.

$$Gain = - \frac{R 2}{R 1 + R p 2} \qquad Equation 3$$

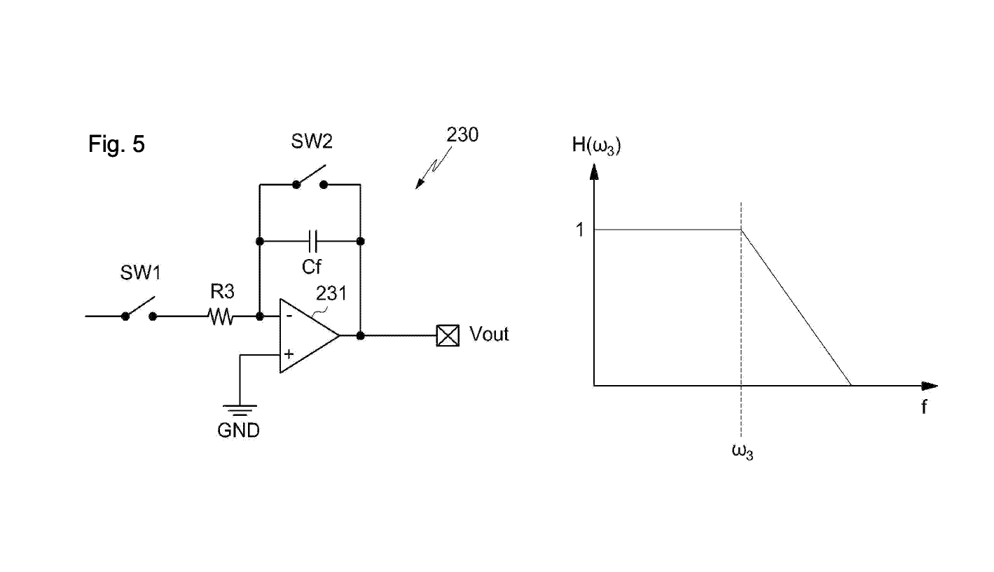

FIG. 5 illustrates the integrator having a low pass characteristic of the touch sensing circuit illustrated in FIG. 2, and a transfer characteristic graph of the integrator.

Referring to FIG. 5, as well known in the transfer characteristic graph illustrated in the right side, the integrator 230 illustrated in the left side has a frequency characteristic the same as that of a low pass filter. A transfer function H(₃) of the integrator 230 is expressed by Equation 4 below.

$$H ( {ω}_{3} ) = - \frac{1}{R 3 \cdot j {ω}_{3} Cf} \qquad Equation 4$$

R3 denotes a third resistor, Cf denotes a feedback capacitor, and ₃ denotes a third cut-off frequency of a low pass filter. Of signal components included in a signal having passed through the high pass filter, a frequency component higher than the third cut-off frequency (₃) does not pass through the integrator 230 and is removed, and the amplitude of a signal in a pass band does not change.

The transfer function H( ) of the tough sensing circuit 200 illustrated in FIG. 3 to FIG. 5 may be expressed by Equation 5 below.

$$H ( ω ) = ( \frac{1}{1 + Rp 1 + jω Cp 1} ) \cdot ( - \frac{j ω Cc \cdot R 2}{1 + j ω Cc ( R 1 + Rp 2 )} ) \cdot ( - \frac{1}{R 3 \cdot j ω Cf} ) \qquad Equation 5$$

The frequency characteristics of the pre-stage 210 having a low pass filter characteristic, the differentiator 220 having a high pass filter characteristic, and the integrator 230 having a low pass filter characteristic are sequentially reflected in the right parenthesis of a sign of equality of Equation 5.

A resistance value of the first sheet resistor Rp1 is decided by the material of a driving electrode, and capacitance of the first sheet capacitor Cp1 is decided by a distance between the touch screen panel 110 and the ground GND, wherein the resistance value and the capacitance are significantly small. Referring to Equation 1 and Equation 5, since the resistance value of the first sheet resistor Rp1 and the capacitance of the first sheet capacitor Cp1 are significantly small, the first cut-off frequency (₁) is significantly high and is relatively higher than the first cut-off frequency (₃) in an actual case. Therefore, in the following description, the characteristic of the low pass filter of the pre-stage 210, which is expressed by the right first parenthesis of a sign of equality of Equation 5, will be omitted.

Referring to Equation 5, the relation between the driving signal Vin of the pre-stage 210 and the output signal Vout of the integrator 230 may be expressed by Equation 6 below.

$$Vout = - \frac{R 2 \cdot Cc}{R 1 + Rp 2} \times \frac{d Vin}{d t} \times - \frac{1}{Cf \cdot R 3} \times \int Vin d t \qquad Equation 6$$

Equation 6 may be simplified as expressed by Equation 7 below.

$$Vout = \frac{R 2}{( R 1 + Rp 2 ) \cdot R 3} \times \frac{Cc}{Cf} \times Vin \qquad Equation 7$$

Referring to Equation 7, the resistance value of the second sheet resistor Rp2 is relatively lower than those of the other three resistors R1, R2, and R3 and is decided by the material of the reception electrode, and the capacitance of the coupling capacitor Cc is also decided by the material of the touch screen panel. However, the first resistor R1, the second resistor R2, the third resistor R3, and the feedback capacitor Cf may be arbitrarily adjusted by a designer.

Equation 5 expresses the transfer function in the frequency domain of the touch sensing circuit 200 according to the present invention, and Equation 7 expresses the transfer function in the time domain. Referring to Equation 5 and Equation 7, the frequency characteristic and the gain in the pass band of the driving signal Vin, which can pass through the touch sensing circuit 200 according to the embodiment of the present invention, can be obtained by adjusting the resistance values of the first resistor R1, the second resistor R2, and the third resistor R3, and the capacitance of the feedback capacitor Cf.

In order to allow the frequency characteristic of the touch sensing circuit illustrated in FIG. 2 to have a characteristic of a band pass filter, the resistance values of the first resistor R1, the second resistor R2, and the third resistor R3, and the capacitance of the feedback capacitor Cf are adjusted such that the second cut-off frequency (₂) is lower than the first cut-off frequency (₁) and the third cut-off frequency (₃). That is, among frequency components included in the driving signal Vin, a frequency component higher than the second cut-off frequency (₂) and lower than the first cut-off frequency (₁) and the third cut-off frequency (₃) passes through the touch sensing circuit 200 according to the embodiment of the present invention, but the other frequency components are blocked.

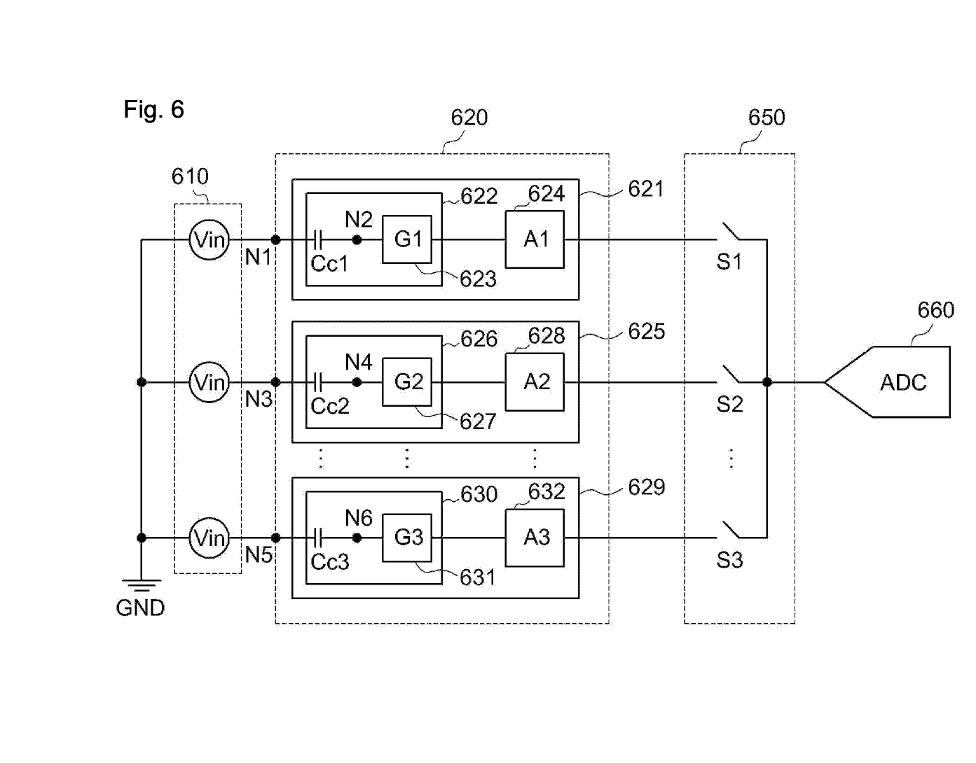

FIG. 6 illustrates a touch sensing system according to the embodiment of the present invention.

Referring to FIG. 6, a touch sensing system 600 includes a driving signal generation block 610, a touch sensing unit 620, a switching block 650, and an analog to digital converter 660.

The driving signal generation block 610 supplies the driving signal Vin to each driving channel.

The touch sensing unit 620 includes a plurality of touch sensing circuits 621, 625, and 629 configured according to a plurality of reception electrodes N1. The plurality of touch sensing circuits 621, 625, and 629 include differentiators 622, 626, and 630, which differentiate the driving signal Vin, and integrators 624, 628, and 632 that integrate output signals of the differentiators 622, 626, and 630, respectively. Each of the differentiators 622, 626, and 630 has a characteristic of a high pass filter that allows only a high frequency component to pass therethrough, and the integrators 624, 628, and 632 has a characteristic of a low pass filter that allows only a low frequency component of a signal output from the high pass filter to pass therethrough.

The differentiators 622, 626, and 630 are included in a touch screen panel and have a structure in which coupling capacitors CC₁, CC₂, and CC₃ formed between a plurality of driving electrodes N1, N3, and N5 and a plurality of reception electrodes N2, N4, and N6 are serially connected to amplification circuits 623, 627, and 631, respectively. Each of the amplification circuits 623, 627, and 631 includes the first resistor R1, the second resistor R2, and the first amplifier 221 illustrated in FIG. 4. Since an internal circuit of each of the integrators 624, 628, and 632 is the same as the integrator 230 illustrated in FIG. 5, a detailed description thereof will be omitted.

The switching block 650 includes a plurality of switches S1, S2, and S3 that switch signals that are output from the integrators 624, 628, and 632 constituting the plurality of touch sensing circuits 621, 625, and 629, respectively. The analog to digital converter 660 converts signals selected from the switching block 650 into digital signals and outputs the digital signals.

In the conventional case, since the driving signal Vin is amplified as is and received, it is necessary to additionally perform a filtering operation in a digital domain with respect to an output signal of an analog to digital converter in order to select only the driving signal Vin except for noise of received signals. However, in the case of the touch sensing circuit and the touch sensing system according to the embodiment of the present invention, since it is possible to selectively receive the driving signal Vin, a system can be simply realized because a filter necessary for the conventional art is not used.

Although a preferred embodiment of the present invention has been described for illustrative purposes, those skilled in the art will appreciate that various modifications, additions and substitutions are possible, without departing from the scope and the spirit of the invention as disclosed in the accompanying claims.

1. A touch sensing circuit, in which a coupling capacitor is generated in a node in which a driving electrode and a reception electrode of a touch screen panel cross each other and a frequency bandwidth of a driving signal applied from the driving electrode and received in the reception electrode is adjusted, the touch sensing circuit comprising:
a high pass filter configured to allow only a high frequency component of the driving signal to pass therethrough; and
a low pass filter configured to allow only a low frequency component of a signal, which is output from the high pass filter, to pass therethrough,
wherein the high pass filter comprises:
the coupling capacitor having a first terminal connected to the reception electrode;
a first resistor connected to a second terminal of the coupling capacitor, the first terminal facing the second terminal;
a first amplifier having a first input terminal grounded, a second input terminal connected to a second terminal of the first resistor, and an output terminal through which a differentiation signal is output, the first input terminal facing the second input terminal; and
a second resistor having a first terminal connected to the second input terminal of the first amplifier, and a second terminal connected to an output terminal of the first amplifier, the first terminal facing the second terminal,
wherein the touch sensing circuit adjusts a width of a reception frequency band.

2. The touch sensing circuit of claim 1, wherein the low pass filter comprises:
a third resistor having a first terminal connected to the output terminal of the high pass filter;
a second amplifier having a first input terminal grounded, a second input terminal connected to a second terminal of the third resistor, and an output terminal through which an integration signal is output, the first input terminal facing the second input terminal; and
a feedback capacitor having a first terminal connected to the second input terminal of the second amplifier, and a second terminal connected to an output terminal of the second amplifier, the first terminal facing the second terminal.

3. The touch sensing circuit of claim 2, wherein the low pass filter further comprises:
a signal transfer switch configured to switch the high pass filter and the third resistor; and
a reset switch configured to reset charge charged in the feedback capacitor.

4. The touch sensing circuit of claim 3, wherein a width of a reception frequency band and gain of the touch sensing circuit are obtained by adjusting resistance values of the first resistor, the second resistor, and the third resistor, and a capacitance value of the feedback capacitor.

5. The touch sensing circuit of claim 4, wherein a cut-off frequency of the low pass filter is higher than a cut-off frequency of the high pass filter.

6. The touch sensing circuit of claim 1, wherein the high pass filter includes a differentiator configured to differentiate the driving signal received through the reception electrode.

7. The touch sensing circuit of claim 2, wherein the low pass filter includes an integrator configured to integrate an output signal of the high pass filter.

8. A touch sensing system, which includes a touch sensing circuit that senses a driving signal applied from a driving electrode of a touch screen panel and transferred to a reception electrode of the touch screen panel and senses whether the touch screen panel is touched, the touch sensing system comprising:
a plurality of touch sensing circuits;
a switching block configured to select signals that are output from the plurality of touch sensing circuits; and
an analog to digital converter configured to convert signals selected by the switching block into digital signals,
wherein each of the plurality of touch sensing circuits includes a high pass filter configured to allow only a high frequency component of a corresponding driving signal to pass therethrough, and a low pass filter configured to allow only a low frequency component of a signal, which is output from the high pass filter, to pass therethrough, and adjusts a width of a reception frequency band.

9. The touch sensing system of claim 8, wherein the high pass filter includes a differentiator configured to differentiate the driving signal that is applied to a corresponding driving electrode, and the low pass filter includes an integrator configured to integrate an output signal of the differentiator.

10. A touch sensing circuit, in which a coupling capacitor is generated in a node in which a driving electrode and a reception electrode of a touch screen panel cross each other and a frequency bandwidth of a driving signal applied from the driving electrode and received in the reception electrode is adjusted, the touch sensing circuit comprising:
a gain circuit configured to amplify the driving signal, which passes through the coupling capacitor and is input to the reception electrode, by preset gain; and
a low pass filter configured to allow only a low frequency component of a signal, which is output from the gain circuit, to pass therethrough,
wherein the gain circuit comprises:
a first resistor having a first terminal connected to the reception electrode;
a first amplifier having a first input terminal grounded and a second input terminal connected to a second terminal of the first resistor, the first input terminal facing the second input terminal, the first terminal facing the second terminal; and
a second resistor having a first terminal connected to the second input terminal of the first amplifier, and a second terminal connected to an output terminal of the first amplifier, the first terminal facing the second terminal,
wherein the low pass filter comprises:
a third resistor having a first terminal connected to the output terminal of the gain circuit;
a second amplifier having a first input terminal grounded and a second input terminal connected to a second terminal of the third resistor, the first input terminal facing the second input terminal; and
a feedback capacitor having a first terminal connected to the second input terminal of the second amplifier, and a second terminal connected to an output terminal of the second amplifier, the first terminal facing the second terminal,
wherein the preset gain is decided by a ratio of the first resistor and the second resistor, and
the gain circuit is coupled with the coupling capacitor and operates as a high pass filter for the driving signal.

11. The touch sensing circuit of claim 10, wherein the low pass filter comprises:
a signal transfer switch configured to switch the output terminal of the gain circuit and the third resistor; and
a reset switch configured to reset charge charged in the feedback capacitor.

12. A touch sensing circuit comprising:
a high pass filter configured to have a first cut-off frequency decided by a first resistance value for adjusting gain, and remove a frequency component included in a signal transferred through a reception electrode of a touch screen panel and lower than the first cut-off frequency; and
a low pass filter configured to have a second cut-off frequency decided by a second resistance value for adjusting gain and capacitance, and remove a frequency component included in output of the high pass filter and high than the second cut-off frequency,
wherein a width of a reception frequency band is adjusted by adjusting the first resistance value, the second resistance value, and the capacitance.

13. The touch sensing circuit of claim 12, wherein the high pass filter includes a differentiator.

14. The touch sensing circuit of claim 12, wherein the low pass filter includes an integrator.

15. The touch sensing circuit of claim 12, wherein the high pass filter comprises:
an amplifier configured to amplify a signal, which is transferred through the reception electrode of the touch screen panel, by a ratio of an input resistor and a feedback resistor,
wherein the first resistance value is decided by the input resistor and the feedback resistor.

16. The touch sensing circuit of claim 12, wherein the low pass filter comprises:
an amplifier configured to amplify the output of the high pass filter by an input resistor having the second resistance value and a feedback capacitor having the capacitance.

17. The touch sensing circuit of claim 16, wherein the low pass filter further comprises:
a reset switch configured to reset charge charged in the feedback capacitor.

18. A touch sensing circuit comprising:
a band pass filter configured to remove a frequency component lower than a first cut-off frequency decided by a first resistance value for adjusting first gain and a frequency component higher than a second cut-off frequency decided by a second resistance value for adjusting second gain and capacitance,
wherein a signal transferred through a reception electrode of a touch screen panel is filtered by the band pass filter, and a width of a filtering band is adjusted by adjusting the first resistance value, the second resistance value, and the capacitance.

19. The touch sensing circuit of claim 18, wherein the band pass filter comprises:
a high pass filter configured to remove the frequency component lower than the first cut-off frequency decided by the first resistance value for adjusting the first gain,
wherein the high pass filter comprises:
an amplifier configured to amplify a signal, which is transferred through the reception electrode of the touch screen panel, by a ratio of an input resistor and a feedback resistor,
wherein the first resistance value is decided by the input resistor and the feedback resistor.

20. The touch sensing circuit of claim 18, wherein the band pass filter comprises:
a low pass filter configured to remove the frequency component higher than the second cut-off frequency decided by the second resistance value for adjusting second first gain and the capacitance,
wherein the low pass filter comprises:
an amplifier configured to amplify output of the high pass filter by an input resistor having the second resistance value and a feedback capacitor having the capacitance.
